(19) United States
(12) Patent Application Publication
(10) Pub. No.: US 2025/0168219 A1
(43) Pub. Date: May 22, 2025

(54) METHOD AND APPARATUS FOR APPLICATION DEVELOPMENT

(71) Applicant: Tencent America LLC, Palo Alto, CA (US)

(72) Inventors: Tim LI, Palo Alto, CA (US); Yuhao QIU, Palo Alto, CA (US); Shiwei LIU, Palo Alto, CA (US)

(73) Assignee: Tencent America LLC, Palo Alto, CA (US)

(21) Appl. No.: 18/614,545

(22) Filed: Mar. 22, 2024

Related U.S. Application Data
(60) Provisional application No. 63/601,210, filed on Nov. 20, 2023.

(51) Int. Cl. H04L 67/02; G06F 8/71; H04L 67/10

(52) U.S. Cl. CPC H04L 67/02; G06F 8/71; H04L 67/10

(57) ABSTRACT

A method includes receiving, by a user interface layer in a client terminal, application code input by a user, processing the input application code by a client-as-a-service layer in the client terminal, and forwarding the input application code to be stored in a cloud-based repository. The method further includes synchronizing application code stored in a cache with application code stored in the cloud-based repository, and performing a runtime remodel on a runtime system based on the input application code.

### INCORPORATION BY REFERENCE

The present application claims the benefit of priority to U.S. Provisional Application No. 63/601,210, “A zero-dependency de-middle-platform runtime-CI/CD method based on the U.S. BlueKing” filed on Nov. 20, 2023, which is incorporated by reference herein in its entirety.

### TECHNICAL FIELD

The present disclosure describes embodiments generally related to software architecture for software application development, including integration and deployment.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Cloud computing can refer to the on-demand availability of computer system resources, especially data storage (cloud storage) and computing power, without direct active management by users. Cloud computing services can provide environments for customers to develop, run and manage web applications without the complexity of building and maintaining any infrastructure associated with developing and launching the applications. Examples of cloud computing services include infrastructure as a service (IaaS), platform as a service (PaaS) and the like.

### SUMMARY

According to an aspect of the disclosure, a method is provided for receiving, by a user interface layer in a client terminal, application code input by a user, processing the input application code by a client-as-a-service layer in the client terminal, and forwarding the input application code to be stored in a cloud-based repository. The method further includes synchronizing application code stored in a cache with application code stored in the cloud-based repository, and performing a runtime remodel on a runtime system based on the input application code.

According to yet another aspect, the client-as-a-service layer runs in a web browser application of the client terminal.

According to yet another aspect, the processing further includes performing version control processing on the input application code.

According to yet another aspect, the performing version control processing includes using a version control library and database mapping of the client-as-a-service layer, where the version control library and the database mapping are stored in the client terminal.

According to yet another aspect, the version control library and database mapping stored in the client terminal are used to communicate with the cache.

According to yet another aspect, the client-as-a-service layer includes a library stored on the client terminal that provides control interfaces to the user interface layer and generates database operations based on the application code input by the user.

According to yet another aspect, the database operations comprise CRUD (Create, Read, Update, Delete) and transaction functions.

According to yet another aspect, the method further includes, in response to receiving the application code, retrieving previously stored application code from the cloud-based repository and performing a runtime remodel function by merging, migrating, or deduplicating existing objects in the previously stored application code, based on the received application code.

According to yet another aspect, the runtime remodel function is performed in the client-as-a-service layer of the client terminal.

According to yet another aspect, the method further includes, in response to receiving the application code, performing a client discovery mechanism in the client-as-a-service layer of the client terminal. In this aspect, the client discovery mechanism comprises identifying other client terminals associated with or affected by the application code and transmitting data to the identified other client terminals for execution or display.

According to another aspect of the disclosure, an apparatus is provided. The apparatus includes processing circuitry. The processing circuitry can be configured to perform any of the described methods.

Aspects of the disclosure also provide a non-transitory computer-readable medium storing instructions which, when executed by a computer, cause the computer to perform any of the described methods.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an exemplary block diagram of a communication system (100).

FIG. 2 is a schematic illustration of an exemplary software architecture of an integrated application development platform system.

FIG. 3 is an example data structure (300) for a front-end JavaScript (JS) object.

FIG. 4 shows a diagram of a graphic user interface (GUI) in the integrated application development platform system.

FIG. 5 shows another diagram of a GUI in the integrated application development platform system.

FIG. 6 shows another diagram of a GUI in the integrated application development platform system.

FIG. 7 shows a diagram of operations in the integrated application development platform system in some examples.

FIG. 8 shows a diagram of runtime remodel structure for Continuous Integration/Continuous Deployment (CI/CD) in some examples.

FIG. 9 shows a diagram of a Client as a Service (CaaS) architecture in some examples.

FIG. 10 shows a diagram for client discovery in some examples.

### DETAILED DESCRIPTION OF EMBODIMENTS

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, these concepts may be practiced without these specific details.

In the present disclosure, some technical terms are used with the following definitions.

Zero-dependency refers to the ability of a method to operate independently without relying on external dependencies or middle platforms. Zero-dependency in the present disclosure indicates the capability of some embodiments of the present disclosure to function independently of external platforms or environments.

De-middle-platforming refers to the process or methodology involved in eliminating reliance on middle/external platforms, particularly referencing removal of dependencies from intermediary systems, such as intermediary systems communicating between application development terminals and cloud storage. The present disclosure applies principles of de-middle-platforming to reduce unnecessary complexity and redundancy.

Deploy-and-forget represents an approach where, once an application or service is deployed, the application or service operates autonomously without requiring continuous monitoring or intervention. Deploy-and-forget aligns with the concept of enabling applications to function seamlessly after deployment without further attention.

Burn-after-use refers to a principle where resources or components are utilized for a specific purpose or duration and then discarded or terminated to prevent ongoing resource consumption. In the present disclosure, burn-after-use can indicate a method where services or components are utilized for specific tasks and then decommissioned automatically to minimize resource consumption.

Frozen-code refers to an approach that enables the expansion of an application's functionalities without requiring additional lines of code. The approach allows for the continuous enhancement of the application's capabilities without directly adding more code, for example through configurations, extensions, or other architectural methodologies rather than constantly modifying the existing codebase.

Object remodel indicates a process of modifying or adapting objects or components within a runtime system without altering the original source code to extend the functionality of an application.

Client-as-a-Service (CaaS) represents a service model where client-side operations or functionalities are delivered as a service. In the present disclosure, in some examples, CaaS refers to a process where the continuous integration/continuous deployment (CI/CD) process is handled at the front-end level. CaaS includes, but is not limited to, code debugging, compiling, deployment, and scheduling, all managed within the front-end environment. Additionally, CaaS may include functions to manage multiple users, handle server resources, process server transactions, and the like.

Rest4DB refers to a library that provides RESTful interfaces or methods for database operations, encompassing CRUD (Create, Read, Update, Delete) and transaction functionalities.

VoDB (version control based on database) refers to a version control library and a database mapping situated on the front-end of an application development system. The version control operates through Rest4DB, utilizing a database implementation.

Runtime-CI/CD denotes continuous integration and continuous deployment (CI/CD) processes executed during the runtime or operation of the application, allowing continuous updates and improvements without interrupting operation of the application.

Generally, infrastructure as a service (IaaS) is a cloud computing service model in which a cloud computing provider provides the computing infrastructure, such as the virtualization, servers, storage and networking facilities on demand for a customer. The customer can pay for the computing resource that the customer uses, thereby avoiding the expense and complexity of buying and maintaining infrastructure resources. Each customer can rent hardware resources separately and the cloud computing provider is responsible for managing and maintaining those hardware resources. A customer can manage, install, configure, and update its own software, operating system, middleware, data, and applications on the rented hardware resources.

Further, platform as a service (PaaS) is a cloud computing service model in which a cloud computing provider offers provisioning and hosting capabilities for a developer (e.g., a customer) to develop, host, and deploy applications (e.g., web applications), thereby saving developers from maintaining, configuring, and managing the underlying hardware, software, and hosting capabilities. The developer's application can operate on one or more virtual machines (VMs) running on top of a hypervisor in a host server of the cloud computing provider. The cloud computing provider can manage the runtime, middleware, operating system, virtualization, servers, storage, and networking facilities, and the developer can maintain its applications.

Generally, cloud computing is based on a client-server model. The client-server model is a distributed structure that partitions tasks or workloads between service requesters and providers. The providers of a resource or service are also referred to as servers in some examples, and the service requesters are also referred to as clients in some examples. In some examples, a server can run one or more server programs, and can share resources with clients. A client usually does not share any of its resources, but requests content or service from a server. Clients can initiate communication sessions with servers, which await incoming requests.

In a cloud computing architecture, the front-end can refer to the client side, and the back-end can refer to the server side. The front-end can include user interfaces, and applications that are used by the client to access the cloud computing services. For example, the front-end can include a web browser to access a cloud computing platform. The back-end can include cloud servers and their applications, databases, operating systems, and the like.

Some aspects of the present disclosure provide techniques that implement server side functionalities at the front-end. The implementation of the server side functionalities at the front-end can be referred to as client as a service (CaaS) in a cloud computing service model.

In some related examples, integration and deployment for application development are handled at the server side, for example by a middle/external platform that is external from the front-end and is positioned “in the middle” between the front-end and the cloud computing infrastructure. In contrast, according to the present disclosure, continuous integration/continuous deployment (CI/CD) operations, such as code debugging, compiling, deployment, scheduling and the like, are handled at the front-end (client side) to enable zero-dependency from any middle/external platforms and provide a flexible, high-efficiency, and low-latency application development and deployment solution.

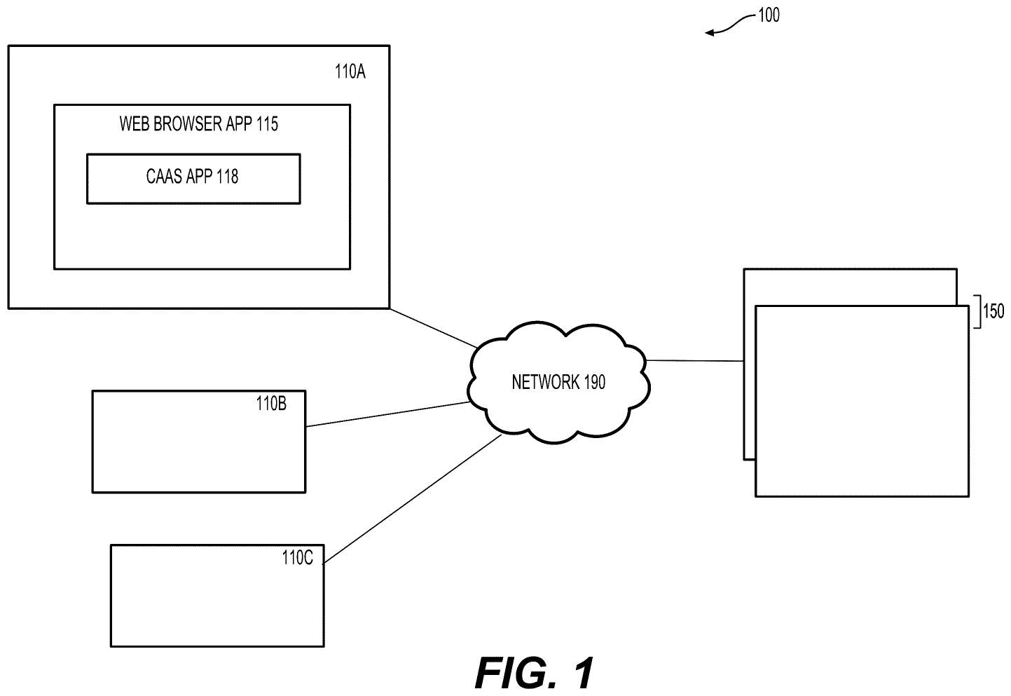

FIG. 1 shows a block diagram of a system (100) for application development and deployment in some examples. The system (100) uses a cloud computing service model with CaaS. In various implementations, the system (100) may include a plurality of user devices (also referred to as client computing devices), such as user devices (110A)-(110C).

The user devices (110A)-(110C) can be any suitable electronic devices, such as desktop computers, notebook computers, netbook computers, tablet computers, smart-phones, and the like. Using the user device (110A) as an example, the user device (110A) can include one or more processors (CPUs) (e.g., processing circuitry) (not shown) and one or more memories (e.g., non-transitory computer-readable storage medium)(not shown). The user device (110A) can execute an operating system (OS) and various applications. In an example, the user device (110A) can execute a web browser application (115) that provides a user interface window.

In some examples, the web browser application (115) may include or execute one or more CaaS applications, such as a CaaS application (118) in FIG. 1, that are configured to perform server functionalities. In an example, the CaaS application (118) is configured to be executed or interpreted by the web browser application (115). In such an example, the CaaS application (118) may be incapable of execution without the aid of the web browser application (115) because the CaaS application (118) is configured to be run inside the browser with a dedicated user interface. In other examples, the CaaS application (118) may be a standalone application that executes independently of the web browser.

In some examples, the code of the CaaS application (118) is bundled, so that the user device (110A) can download all of the content of the CaaS application (118) for execution by the web browser application (115). In some examples, the CaaS application (118) can use an extension application programing interface (API) to augment the functionality of the web browser.

In some examples, the CaaS application (118) is configured to be a browser extension for the web browser application (115). Thus, the CaaS application (118) can provide extra functionality to the web browser application (115). In an example, the CaaS application (118) can extend the functionality of the web browser application (115) by adding a new button, such as a language switch button. For example, clicking the language switch button can convert all texts on the website presented to a user into a language chosen by the user.

In the FIG. 1 example, the system (100) includes a plurality of servers (150) to provide various service to the user devices (110A)-(110C) via a network (190). In some examples, a server (150) can include one or more processors (not shown) and one or more memories (not shown) storing one or more service applications. The one or more processors can execute the service applications to provide the corresponding services.

In an example, a server (150) can support data uploading or storage services.

In another example, a server (150) can provide a software development service. For example, the server (150) can provide an APP market of applications, such as a repository of an application database, that can be accessed by the user devices (110A)-(110C) via the network (190).

According to some aspects of the disclosure, the system (100) is configured as a software development system, and the CaaS application (118) is configured to perform server functions at the client side to achieve zero-dependency de-middle-platform runtime-continuous integration (CI)-continuous deployment (CD) for software development.

The following description uses a software application development platform as an example to further describe the system (100). One example of such a software application development platform is the BlueKing platform developed by Tencent. It is noted that the system (100) can be suitably adjusted to support other service systems.

Generally, software application development platforms allow users to create, deploy and manage applications. For example, such platforms provides complete front- and back-end development frameworks, enterprise service bus (ESB), scheduling engines, and public components. Other services that may be provided by software application development platforms may include log query, monitoring, and alarming.

Related implementations of such software application development platforms are based on a middle platform. A middle platform (also referred to as middle-platform component) refers to a platform that is external to the front-end user devices and organizes reusable services to meet the needs of developers using the front-end user devices. For example, a related Chinese implementation of the BlueKing platform includes a BlueKing core portion and middle-platform components.

In an example, the middle-platform components of the related implementations may include a pipeline platform (e.g., BlueShield pipeline used by Chinese BlueKing platform) that provides a set of automated processes and tools that allows both developers and operations professionals to cooperate to build and deploy code to a production environment.

In another example, the middle-platform components of the related implementations may include a Git platform (e.g., GongFeng Git used by Chinese BlueKing platform) that provides a version control system used for tracking changes in computer files. The Git platform can allow multiple developers to work together and support non-linear development by supporting parallel branches.

It is noted that in the related implementation of the Chinese BlueKing platform, the middle-platform components are located at the back-end and implemented at the server side.

In some related examples, functions of the middle-platform components can be implemented as separate applications that are provided by servers. In some examples, functions of each of the middle-platform components can be provided by separate service providers, and can require separate password for usage. Further, modification and implementation of functions of the middle-platform at the back-end side can be limited. For example, geographic differences between the location of the front-end and back-end systems may result in regulatory or technical limitations to the functions that may be provided by the back-end.

The present disclosure provides techniques to implement operations and functionalities at the client-side as services, and the implemented service model at the client-side is referred to as client as a service (CaaS). In some examples, operations and functionalities of middle-platform components are implemented at the front-end (client side) of a software platform system. Thus, the integrated application development platform system described in the present disclosure is independent of any middle-platform components. Further, various additional features can be implemented in the CaaS, which may not require additional authentication from the front-end user devices in some examples.

According to an aspect of the disclosure, while the CaaS is implemented mainly at the front-end, the back-end may be suitably adjusted to allow the functionality of CaaS in the front-end in some examples.

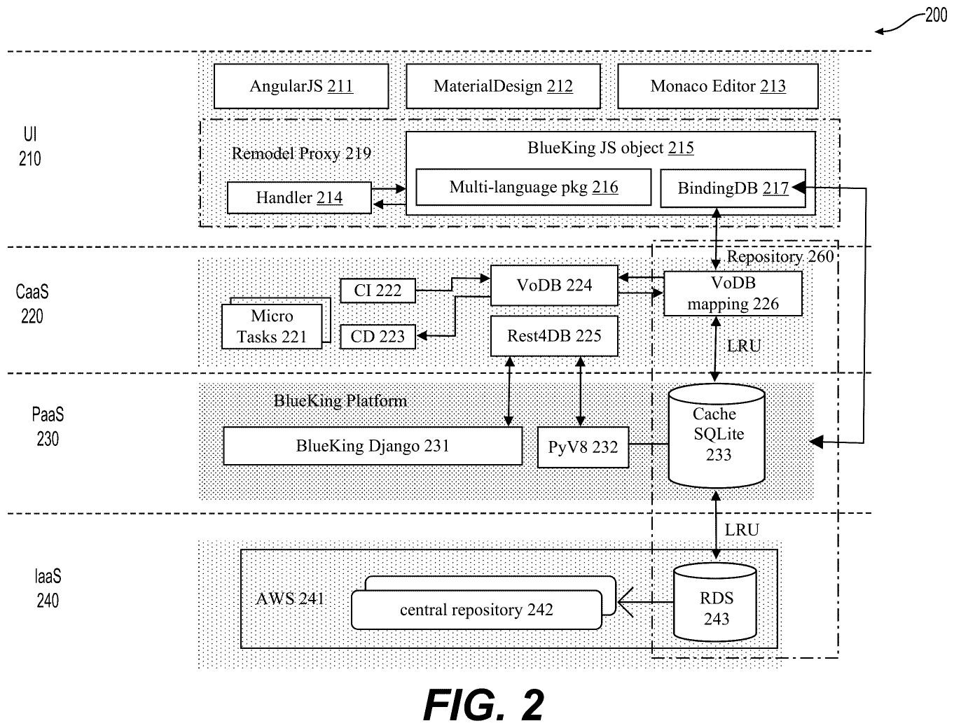

FIG. 2 shows a diagram of a software architecture (200) of the integrated application development platform system in some examples. The software architecture (200) includes a plurality of layers, such as a user interface (UI) layer (210), a CaaS layer (220), a platform as a service (PaaS) layer (230) and an infrastructure as a service (IaaS) layer (240), as shown in FIG. 2. The UI layer (210) and the CaaS layer (220) may be implemented at the front-end, and the PaaS layer (230) and the IaaS layer (240) may be implemented at the back-end.

In some examples, the UI layer (210) includes the front-end components of the integrated application development platform system, and other suitable UI components. The UI layer (210) may be implemented in a web browser and configured to provide user interface functionalities. In an example, the UI layer (210) for the integrated application development platform system includes a JavaScript Object (such as the BlueKing JS object (215)) and an open-source UI framework. For example, the open-source UI framework may include but is not limited to AngularJS (211), MaterialDesign (212), Monaco Editor (213) and other components (not shown), such as React.js, Vue.js, Ember.js, Backbone.js, and the like that are employed to augment the front-end components of the integrated application development platform system. Other suitable UI components, such as alternatives for AngularJS (211), MaterialDesign (212), Monaco Editor (213), React.js, Vue.js, Ember.js, Backbone.js, or other front-end UI frameworks can be used in the UI layer (210).

In some examples, the suitable open source UI components in the UI layer (210) can present the user interface, and provide front-end templates. For example, AngularJS (211) may be used to generate and provide front-end templates.

In some examples, the JavaScript Object, such as the BlueKing JS object (215), includes data structure objects provided by the integrated application development platform system for the front-end.

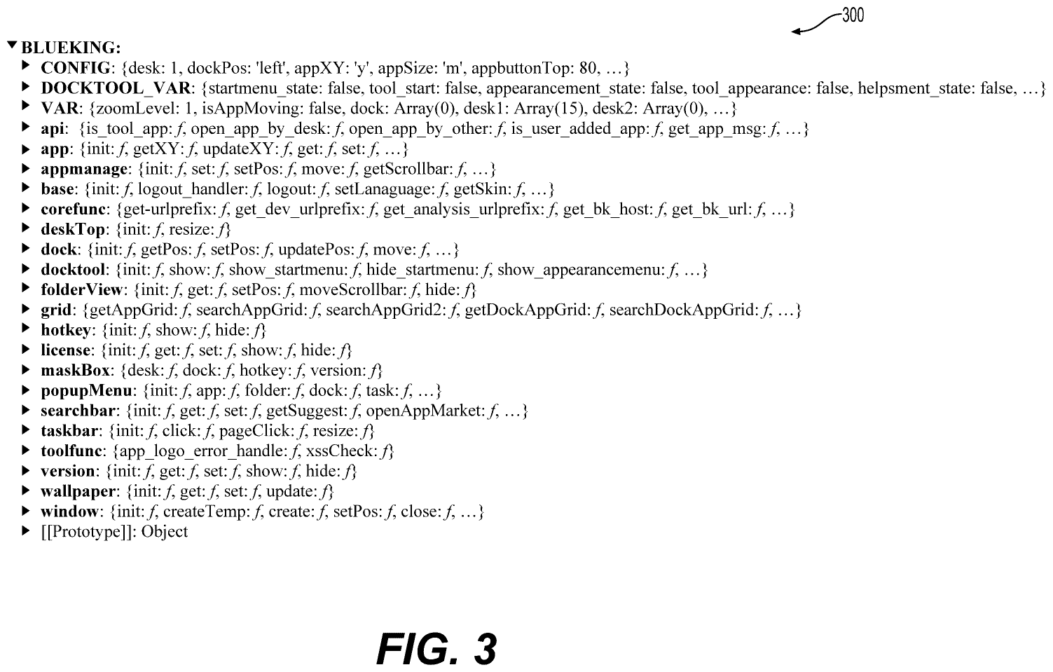

FIG. 3 shows an example syntax (300) for the BlueKing JS object (215) in some examples. The syntax (300) includes data structure objects provided by the integrated application development platform system. The data structure objects can be integrated into the integrated application development platform system at the front-end, such as the UI layer (210).

In some examples, the JavaScript Object, such as the BlueKing JS object (215), includes multi-language package (216) that can be used for real time translation at the client-side, to obviate server communication for language translation.

In another example, the BlueKing JS object (215) may include a bindingDB (217) which is a small database for data binding. The bindingDB (217) is configured to bind data sources from the provider and consumer together and synchronize them. For example, the bindingDB (217) can bind JavaScript UI elements to JavaScript objects. In an example of a data binding process, data changes are reflected automatically by the UI elements that are bound to the data.

Remodel proxy (219) of the UI layer (210) includes the JavaScript Object (e.g., BlueKing JS object 215) and a handler (214). The handler (214) handles changes and communications coming from the the CaaS layer (220) to cause runtime remodel at the UI layer (210).

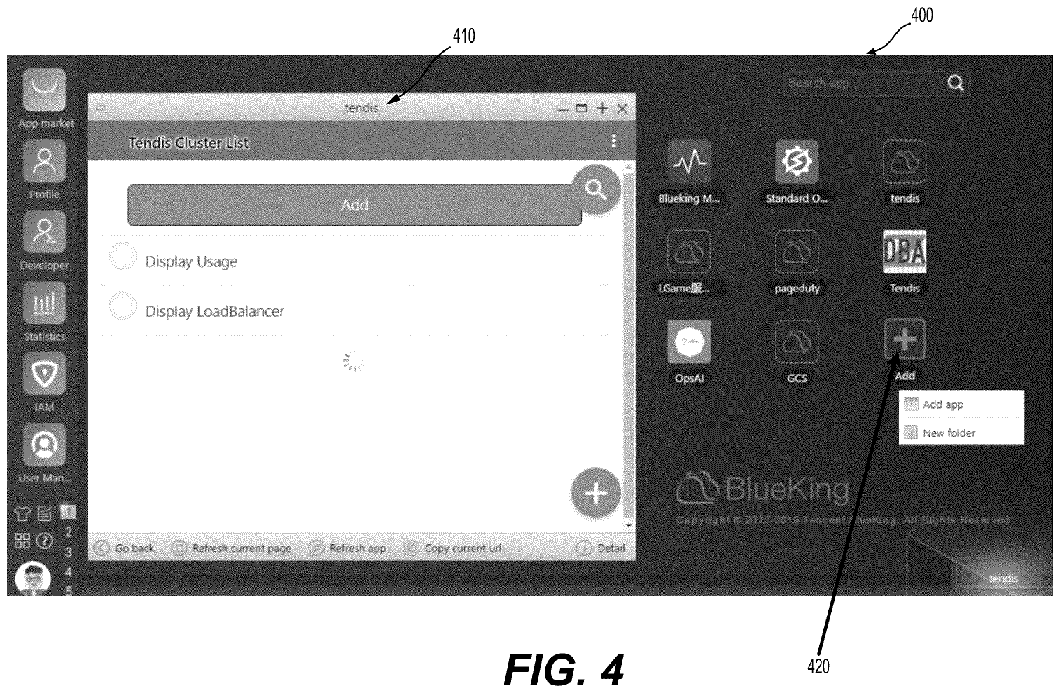

FIGS. 4-6 show diagrams of graphic user interfaces used in the integrated application development platform system in some examples.

FIG. 4 shows a diagram of a graphic user interface (GUI) (400) in the integrated application development platform system. The integrated application development platform system in the example of FIG. 4 is used to develop applications, such as an application that is shown as a window (410) for an application named “tendis.”

In the FIG. 4 example, the GUI (400) represents the user interface of the integrated application development platform system, and the window (410) represents the main interface of the application “tendis.”

In FIG. 4, the application “tendis” is developed using the methodology of the integrated application development platform system. In the FIG. 4 example, an “Add” icon (420) in the bottom right corner of the GUI (400) can be used to access an application market in the integrated application development platform system. By clicking the “Add” icon, in an example, the application market can be accessed, enabling the addition and removal of apps developed by the integrated application development platform system.

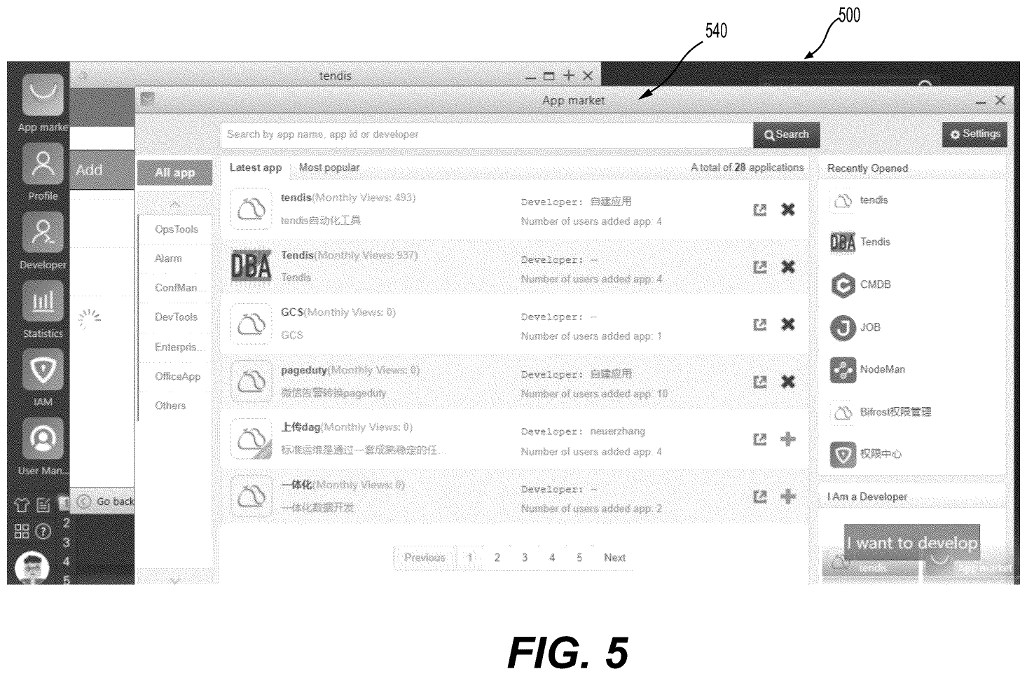

FIG. 5 shows a diagram of a GUI (500) when an application market is accessed in some examples. The GUI (500) includes a list of applications in the application market. Addition of applications and removal of applications can be operated on applications in the list of applications within the application market.

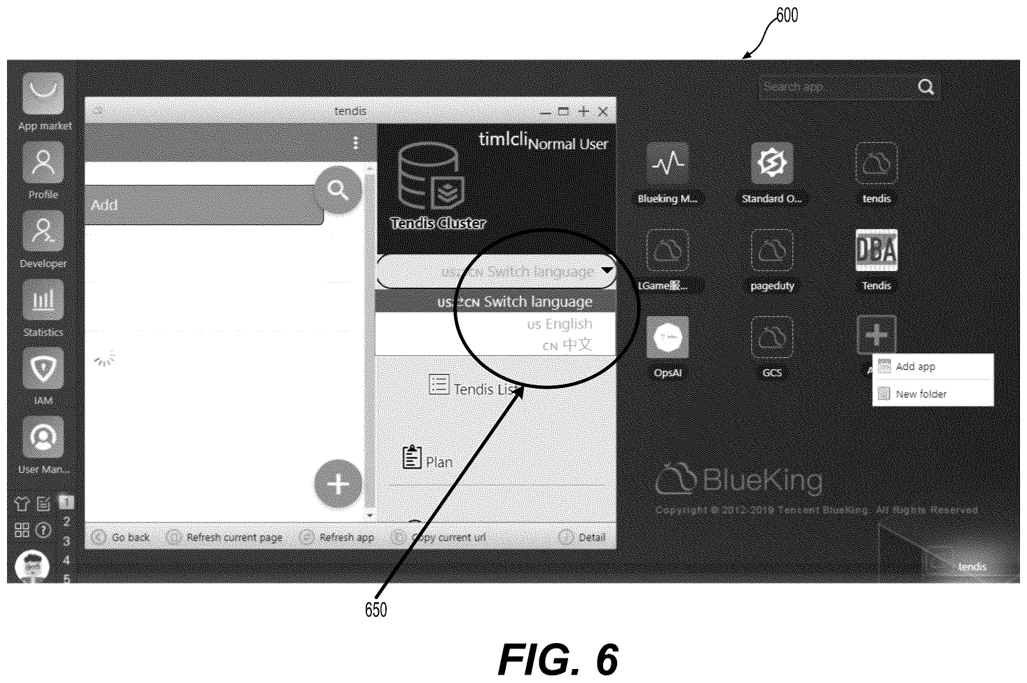

FIG. 6 shows a diagram of a GUI (600) with real-time multi-language translation functionality. In some examples, the real-time multi-language translation functionality is implemented at the client-side, and can be performed without the need for server communications. In the FIG. 6 example, the GUI (600) includes a drop-down selection (650) that can be used to select a language from a list of languages. Text in the GUI (600) can be converted to the selected language without refreshing (e.g., no need to communicate with a server for refreshing). In some examples, suitable style visual effects can be implemented with suitable languages. The multi-language translation functionality can improve interaction efficiency between developers with different native languages.

Referring back to FIG. 2, in some examples, the PaaS layer (230) may be a service module (BlueKing platform in the example of FIG. 2) configured to support the integrated application development platform system. In the FIG. 2 example, the server side service module of the PaaS layer (230) may include a web server framework, such as BlueKing Django (231). In some examples, the web server framework (e.g., BlueKing Django (231)) solely supports Python programing language. In other examples, a JavaScript engine, such as Google V8, may be included in the web server framework as a high-performance JavaScript and WebAssembly engine. In the FIG. 2 example, the service module may include a language conversion module, such as shown by PyV8 (232) in FIG. 2. PyV8 (232) is a python wrapper for Google V8 engine, and acts as a bridge between Python and JavaScript objects. The use of PyV8 (232) may support hosting the Google V8 engine in a Python script.

It is noted that other suitable language conversion modules can be used instead of or additionally to PyV8 (232). It is also noted that, in some examples, language conversion module are not needed in the service module of the PaaS layer (230).

In the FIG. 2 example, the IaaS (240) is implemented based on Amazon web services (AWS) (241). It is noted that other suitable cloud computing platforms can be used in the place of AWS (241). AWS (241) provides computing resources, such as servers, storage, networking, virtualization, and the like to the integrated application development platform system. In the FIG. 2 example. AWS (241) can provide central repository (242) and relational database service (243) to the integrated application development platform system.

Still referring to FIG. 2, in some examples, the CaaS layer (220) is situated at the client-side within a web browser, and can accomplish server-side functionalities that are distinct from functions of the UI layer (210). In some examples, the CaaS layer (220) is implemented as a JavaScript library on the front-end. Thus, the CaaS layer (220) can operate either as a front-end function or as a background service. The CaaS layer (220) is configured to perform back-end logic that is performed at the server side in some related examples (e.g., Chinese BlueKing platform system), such as multi-user sharing, server resource operations, and transaction handling. As described above, moving functionality of the CaaS layer (220) to the front-end allows for a zero-dependency approach to a Continuous Integration/Continuous Deployment (CI/CD) process that avoids the pitfalls of a distributed platform architecture.

In the FIG. 2 example, the CaaS layer (220) includes various functionalities, such as micro tasks (221), continuous integration (CI) (222), continuous deployment (CD) (223), version control (shown by VoDB 224), pipeline (shown by Rest4DB 225), and VoDB mapping (226).

In some examples, Rest4DB (225) is a JavaScript library on the front-end that provides control interfaces to the UI layer (210) and communicates with a Rest4DB Python library on the back-end (e.g., PyV8 232 in the PaaS layer 230) through an interface, such as RestAPI. In an example, PyV8 (232) supplies Rest4DB (225) with fixed RestAPI interfaces, for example four APIs respectively for create, read, update and delete (CRUD) operations and transactions. The Rest4DB (225) can translate CRUD operations into corresponding UI operations. In some related applications, a large number of APIs (e.g., over 100 APIs) between back-end (e.g., PaaS) and front-end are used, and new APIs need to be added in response to new functions introduced at the front-end. Such a large number of APIs used in the related applications can limit scalability and flexibility. The present disclosure uses a fixed number (e.g., 4) of APIs between the PaaS and the CaaS, which can reduce the development load of RestAPI, and also enables the application to retain the scalability and flexibility advantages of RestAPI. When new functions at the front-end are developed, Rest4DB (225) can map the UI operations of the new functions to the four APIs for CRUD operations. This implementation is referred to as a frozen-code design that allows an application to expand its functionalities without the addition of code at the back-end, for example at the RestAPI in the PaaS layer (230).

In an example, the version control is implemented using VoDB (224).

In an example, the pipeline is implemented using Rest4DB (225).

In some examples, the VoDB mapping (226), a cache (233) in the PaaS layer (230), such as SQLite, and the RDS (243) form repository (260) for the integrated application development platform system.

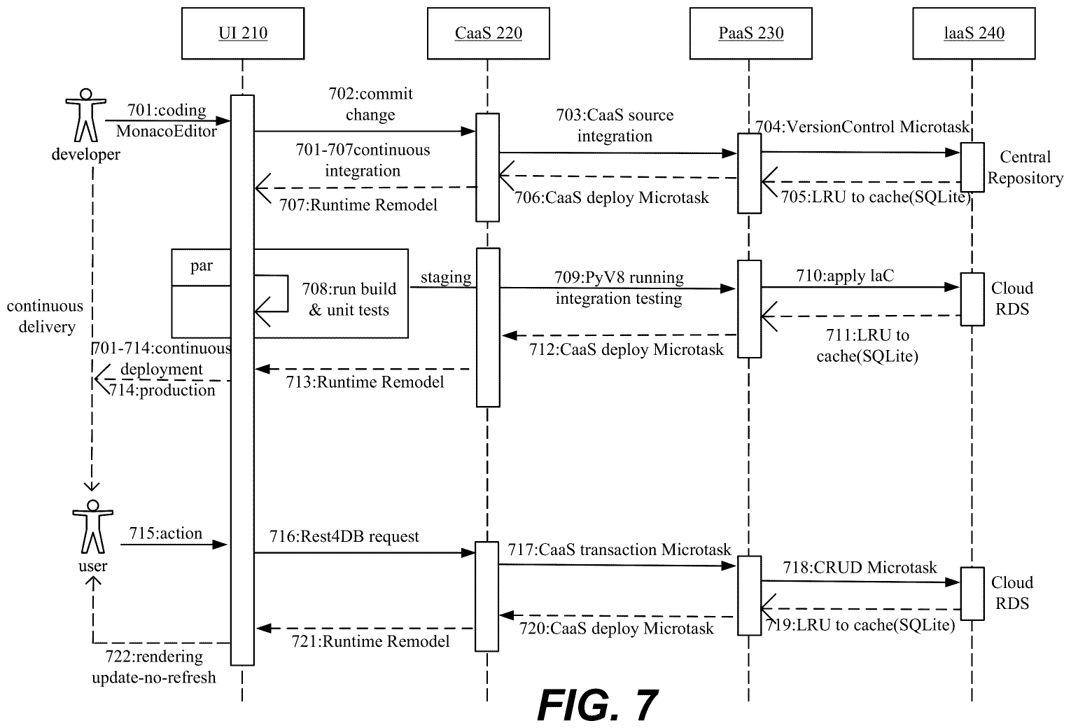

FIG. 7 shows a diagram of operations in the integrated application development platform system in some examples.

At step (701), a developer can directly modify application source code (or input application code) in a development environment on the front-end via the UI layer (210), such as using the Monaco Editor (213). In an example, the changes to the application source code can be reflected in the bindingDB (217).

At step (702), the developer commits the changes to the application source code. The changes are then handled by the CaaS layer (220).

Then, in step (703), the CaaS layer (220) can cause the changes to be saved in the repository (260), for example by forwarding the input application code to be stored in the repository (260). For example, the changes reflected in the bindingDB (217) are saved to the cache (233) (e.g., SQLite, and the like) via a version control module. In the FIG. 2 example, the version control module is implemented as VoDB (224) and VoDB mapping (226). Then, in step (704), through the LRU algorithm, the changes are pushed to the cloud database, which may include RDS (243) and central repository (242). In some examples, the cache (233) (which may include SQLite) remains synchronized with the cloud database RDS (243) using the LRU algorithm. This allows for seamless run-time CI/CD solely from the client-side, once deployed, functioning as a deploy-and-forget background service that requires no further attention. The updated/modified code is accessed automatically upon app events and ceases upon completion, following the principle of burn-after-use. This approach avoids polling, standby, or other consumption of resources associated with client/server communications.

For example, at step (703), the CaaS layer (220) sends a CaaS source integration message to the PaaS layer (230). At step (704), the PaaS layer (230) provides version control microtask to the IaaS layer (240). Then, the changes are saved to the central repository as described above.

At step (705), the LRU algorithm causes the cache (233) to be synchronized with the central repository.

At step (706), the PaaS layer (230) sends an instruction to the CaaS layer (220) to cause the CaaS layer to deploy a microtask that triggers a runtime remodel.

At step (707), the CaaS layer (220) can interact with the UI layer (210) to run the runtime remodel at the UI layer (210), for example by the handler (214) of the remodel proxy (219). Then, the previously made code changes are reflected in the development environment.

It is noted that steps (701) to (707) are for continuous integration in the development environment at runtime, and no down time of the application for update is needed.

Further, tests in a staging or test environment may be performed. The staging environment is used for pre-production testing to identify flaws and vulnerabilities before releasing the product to users. In some examples, a dedicated staging environment is integrated into continuous integration/continuous development (CI/CD) pipelines to simulate software before its release and remediate any underlying issues.

At step (708), a staging environment is integrated for performing parallel tests, such as build and unit tests.

At step (709), CaaS layer (220) messages the PaaS layer (230) for PyV8 (232) to run integration testing.

At step (710), the PaaS layer (230) communicates with the IaaS layer (240), such as the RDS 243, to apply infrastructure as code (IaC) for infrastructure management and provisioning.

Because manual infrastructure management is time-consuming and prone to error, especially when managing applications at scale, infrastructure as code (IaC) can define machine-readable infrastructure configuration files that may be used to define and deploy infrastructure, such as networks, servers, virtual machines, load balancers, and connection topologies.

At step (711), the LRU algorithm synchronizes the cache (233 with the central repository.

At step (712), the PaaS layer (230) sends instructions to the CaaS layer (220) to cause CaaS deploy a microtask that triggers a runtime remodel.

At step (713), the CaaS layer (220) can interact with the UI layer (210) to perform the runtime remodel at the UI layer (210), for example by the handler (214) of the remodel proxy (219).

At step (714), the UI layer (210) releases the changes for production. Then, the changes to the production environment, for example, to a UI layer (210) for a user are reflected.

It is noted that steps (701) to (714) are for continuous deployment at runtime, and no down time of the application for update is needed.

At step (715), in a production environment, an action is taken in a UI layer (210) by a user.

At step (716), the UI layer (210) sends a Rest4DB request to the CaaS layer (220) based on the action taken by the user.

At step (717), CaaS layer (220) generates a transaction microtask for the PaaS layer (230) based on the action taken by the user.

At step (718), the PaaS layer (230) communicates with the IaaS layer (240) by transmitting a CRUD microtask corresponding to the action taken by the user.

At step (719), the LRU algorithm causes the cache (233) to be synchronized with the central repository. For example, any update in the central repository is loaded to the cache (233).

At step (720), the PaaS layer (230) sends instructions to the CaaS layer (220) to cause the CaaS layer (220) to deploy a microtask that triggers a runtime remodel.

At step (721), the CaaS layer (220) can interact with the UI layer (210) to perform the runtime remodel at the UI layer (210), for example by the handler (214) of the remodel proxy (219).

At step (722), the UI layer (210) renders an update to the user without refreshing. At this point, the changes in the production environment made by the action of the user at step (715) is reflected to the user at the UI layer (210).

According to an aspect of the disclosure, the software architecture (200) enables independent development and deployment, resolving limitations tied to related middle-platform dependencies. By strategically integrating technologies like CaaS, Rest4DB, and VoDB into the front-end, the software architecture (200) can circumvent reliance on middle-platforms like BlueShield pipeline or GongFeng Git, allowing the development of application without these dependencies.

Some aspects of the disclosure provide techniques for runtime remodel for CI/CD, for example at steps (707), (713), and (721) in the example of FIG. 7.

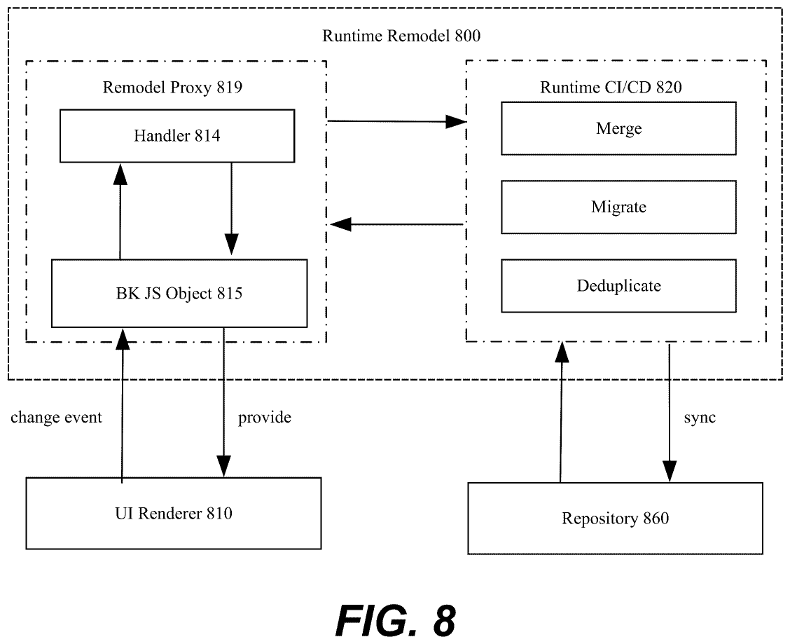

FIG. 8 shows a diagram of runtime remodel structure (800) for CI/CD in some examples. According to an aspect of the disclosure, the runtime remodel is implemented based on an interpreted language, using for example JavaScript Proxy ES6. In such an implementation, the code can be retrieved from the code repository during runtime and the existing objects can be remodeled accordingly without adding objects or modifying the original source code. For example, in the runtime remodel, existing elements can be migrated, merged, and deduplicated, thereby the runtime remodel can achieve runtime-CI/CD of the original system with expanded functionality.

Specifically, in the FIG. 8 example, the runtime remodel structure (800) includes components in the UI layer (210) and components in the CaaS layer (220). For example, the runtime remodel structure (800) includes a remodel proxy (819) in the UI layer (210) and a runtime CI/CD module (820) in the CaaS layer (220). In an example, the remodel proxy (819) corresponds to remodel proxy (219) shown in the example of FIG. 2. For example, the remodel proxy (819) includes a handler (814) and a BlueKing JS object (815), which correspond to handler (214) and JavaScript Object (215) in the example of FIG. 2. The runtime CI/CD module (820) corresponds to CI module (222) and CD module (223) in the example of FIG. 2, and can include other suitable components, such as VoDB, Rest4DB, and the like to enable runtime CI/CD.

In the FIG. 8 example, a runtime remodel can be triggered by a change event, the change event can be any suitable event, such as an initialization, an update, and the like. In the example of FIG. 7, change events (701) and (715) trigger a subsequent runtime remodel. The remodel proxy (819) can communicate with the runtime CI/CD module (820). The runtime CI/CD module (820) can cause code to be retrieved from the code repository (860). The code repository (860) corresponds to the repository (260) in FIG. 2. The runtime CI/CD module (820) can then migrate, merge, and deduplicate existing objects in the retrieved code for remodeling. The remodeled objects can be sent to the remodel proxy (819), and further provided to the UI renderer (810).

According to an aspect of the disclosure, runtime CI/CD can be achieved over the entire application product. The runtime CI/CD functionality can be achieved using algorithms including migration, deduplication, and merging, as described above with reference to FIG. 8. In some examples, runtime CI/CD can be implemented based on JavaScript Proxy ES6, a proxy pattern, an observer pattern, and the like.

In some implementation examples, runtime CI/CD brings significant improvements by generating visually appealing, responsive, user-friendly interfaces, and achieves a 25% increase in user interaction efficiency. The use of the runtime remodel structure (800) also facilitates seamless scalability and runtime CI/CD. Additional advantages of the runtime remodel structure (800) include reduced storage and computation, decreased code volume, enhanced performance, compliance with Occam's razor principle, and faster and more frequent software update releases. This approach reduces computing and storage costs while improving efficiency.

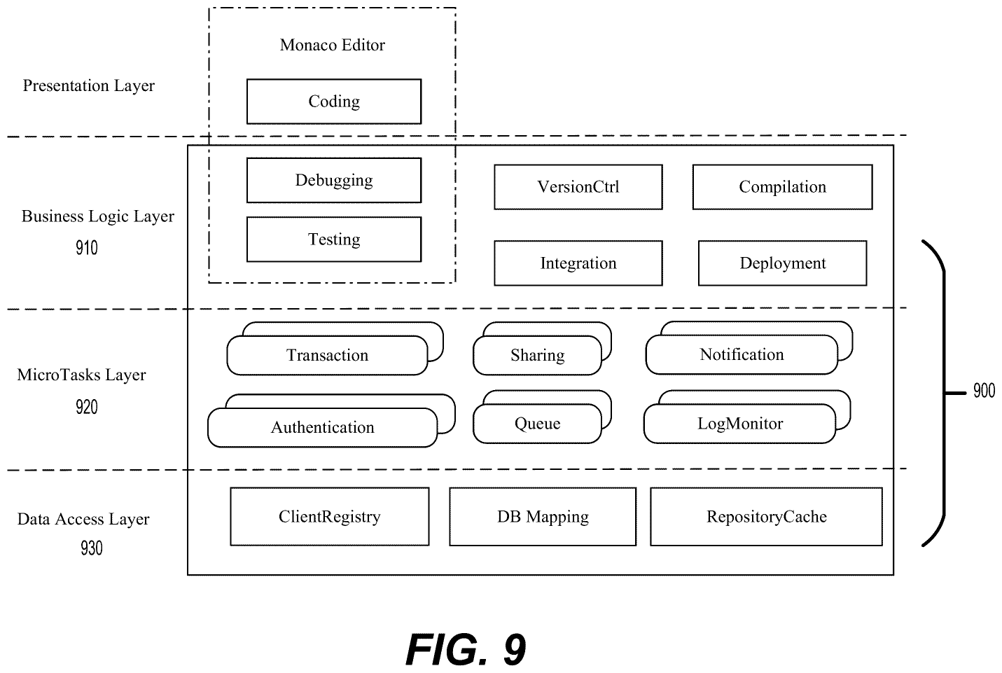

FIG. 9 shows a diagram of CaaS architecture (900) in some examples. In the FIG. 9 example, the CaaS architecture (900) includes 3 layers that are referred to as a business logic layer (BL) (910), a microtasks layer (MTL) (920), and a data access layer (DAL) (930).

In the FIG. 9 example, the business logic layer (910) includes components that are configured to perform debugging, testing, compilation, version control, integration, and deployment. The microtasks layer (920) includes components that are configured to perform transaction, authentication, sharing, queue operation, notification, log monitoring, and the like. The data access layer (930) includes components that are configured to perform client registry, DB mapping, repository cache, and the like.

According to an aspect of the disclosure, with the runtime remodel mechanism (e.g., the runtime remodel structure (800)) and CaaS architecture (e.g., the CaaS architecture (900)), the entire CI/CD process can be carried out at the front-end, including code debugging, compilation, deployment, and scheduling.

According to an aspect of the disclosure, the front-end is configured to handle multiple users, manage server resources, and process server transactions. For example, client discovery is handled at the client-side, for example by the CaaS layer (220).

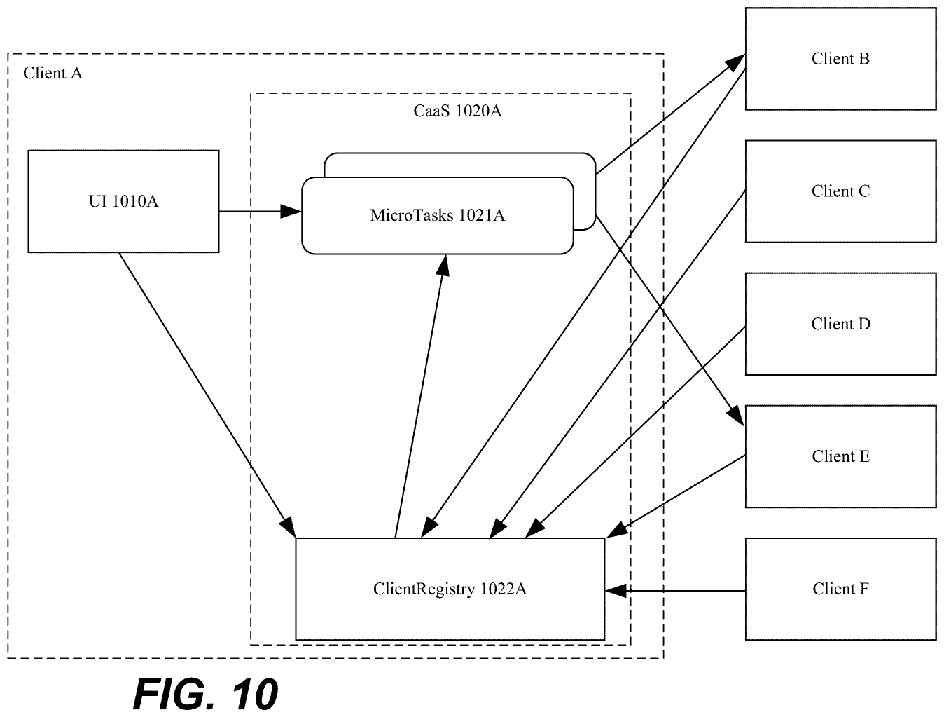

FIG. 10 shows a diagram for client discovery in some examples. In some examples, multiple users (also referred to as clients) are involved in a service oriented task, which may be, for example, coding or user actions such as steps (701) and (715) in FIG. 7. In related examples, such client interactions are handled at the back-end by a server. In some examples of the present disclosure, the client interactions, client discovery, and the like are handled by CaaS layer (220) at the front-end (client-side).

In FIG. 10, a service architecture includes a plurality of clients, such as shown by clients A-F. Each client can correspond to a client terminal. Each client terminal can be configured to include an UI layer and a CaaS layer, such as the UI layer (210) and the CaaS layer (220) in FIG. 2. For example, client A includes a UI layer (1010A) and a CaaS layer (1020A). The CaaS layer (1020A) includes micro tasks (1021A) module and client registry module (1022A). The client registry module (1022A) is configured to perform, at the client-side, similar operations as a server-side registry would perform in related examples.

The client registry module (1022A) can track related information of each client involved in an application development platform. As shown in FIG. 10, each of clients B-F send related client information to the client A and the client registry module (1022A) can include a database to store the related client information and provide access to the related client information. It is noted that client A also sends related client information to the clients B-F. In an example, each of the clients sends related client information to other clients in the platform and each of the clients maintains a corresponding client registry module to store client information related to the other clients.

In some examples, upon receipt of distinct task types, including service-oriented tasks, shared tasks involving multiple users, or transactional tasks, the CaaS layer (1020A) engages a client-discovery mechanism. The client-discovery mechanism operates to identify and allocate the pertinent tasks and associated data to the appropriate client (user) for subsequent execution or display. For example, during operation, a task is generated, for example, from the client A. In the FIG. 10 example, information of the task is provided to the CaaS layer (1020A), for example to the micro tasks module (1021A) and the client registry (1022A). The client registry (1022A) can determine a group of clients (e.g., client B and client E) that are involved in or affected by the task, and provide information of the group to the micro task module (1021A). The micro task module (1021A) can send the task to the group of clients (e.g., client B and client E).

In some examples, the process of the CaaS layer (1020A) involves the categorization of incoming tasks based on their nature and scope within the CaaS architecture. For example, service-oriented tasks typically entail specific actions or functions to be carried out, shared tasks involve collaboration or data sharing among multiple users, multi-user tasks encompass operations requiring concurrent handling by multiple users, while transactional tasks involve critical or transaction-based operations.

Further, in some examples, upon task identification and classification, the client-discovery mechanism of the CaaS layer (1020A) evaluates the context and requirements of the received task. Subsequently, the CaaS layer (1020A) orchestrates the allocation of the task, including any requisite data payloads or instructions, to the designated client terminal(s) within the application development system. The allocation ensures that the identified client(s) possess the necessary resources and capabilities to adequately execute or visually represent the task.

Further, in some examples, the client-discovery mechanism of the CaaS layer (1020A) operates to maintain synchronization and coherence between tasks and their corresponding clients. The synchronization can guarantee that the task allocation aligns with the operational capabilities and constraints of the client, optimizing task execution or visualization while maintaining system efficiency.

Overall, the client-discovery mechanism of the CaaS layer (1020A) can play a pivotal role in task distribution, ensuring precise and efficient assignment of diverse task types to their respective clients for execution or display, thereby enhancing the operational fluidity and user experience within the system described in the present disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method comprising:
receiving, by a user interface layer in a client terminal, application code input by a user;
processing the input application code by a client-as-a-service layer in the client terminal and forwarding the input application code to be stored in a cloud-based repository;
synchronizing application code stored in a cache with application code stored in the cloud-based repository; and
performing a runtime remodel on a runtime system based on the input application code.

2. The method according to claim 1, wherein the client-as-a-service layer runs in a web browser application of the client terminal.

3. The method according to claim 1, wherein the processing further comprises performing version control processing on the input application code.

4. The method according to claim 3, wherein the performing version control processing comprises using a version control library and database mapping of the client-as-a-service layer, where the version control library and the database mapping are stored in the client terminal.

5. The method according to claim 4, wherein the version control library and database mapping stored in the client terminal are used to communicate with the cache.

6. The method according to claim 1, wherein the client-as-a-service layer includes a library stored on the client terminal that provides control interfaces to the user interface layer and generates database operations based on the application code input by the user.

7. The method according to claim 6, wherein the database operations comprise CRUD (Create, Read, Update, Delete) and transaction functions.

8. The method according to claim 1, further comprising, in response to receiving the application code, retrieving previously stored application code from the cloud-based repository and performing a runtime remodel function by merging, migrating, or deduplicating existing objects in the previously stored application code, based on the received application code.

9. The method according to claim 8, wherein the runtime remodel function is performed in the client-as-a-service layer of the client terminal.

10. The method according to claim 1, further comprising, in response to receiving the application code, performing a client discovery mechanism in the client-as-a-service layer of the client terminal,
wherein the client discovery mechanism comprises identifying other client terminals associated with or affected by the application code and transmitting data to the identified other client terminals for execution or display.

11. An apparatus comprising:
processing circuitry configured to
receive, by a user interface layer in a client terminal, application code input by a user;
process the input application code by a client-as-a-service layer in the client terminal and forward the input application code to be stored in a cloud-based repository;
synchronize application code stored in a cache with application code stored in the cloud-based repository; and
perform a runtime remodel on a runtime system based on the input application code.

12. The apparatus according to claim 11, wherein the client-as-a-service layer runs in a web browser application of the client terminal.

13. The apparatus according to claim 11, wherein the processing circuitry is further configured to perform version control processing on the input application code.

14. The apparatus according to claim 13, wherein the processing circuitry is further configured to use a version control library and database mapping of the client-as-a-service layer to perform the version control processing, where the version control library and the database mapping are stored in the client terminal.

15. The apparatus according to claim 14, wherein the version control library and database mapping stored in the client terminal are used to communicate with the cache.

16. The apparatus according to claim 11, wherein the client-as-a-service layer includes a library stored on the client terminal that provides control interfaces to the user interface layer and generates database operations based on the application code input by the user.

17. The apparatus according to claim 16, wherein the database operations comprise CRUD (Create, Read, Update, Delete) and transaction functions.

18. The apparatus according to claim 11, wherein the processing circuitry is further configured to, in response to receiving the application code, retrieve previously stored application code from the cloud-based repository and perform a runtime remodel function by merging, migrating, or deduplicating existing objects in the previously stored application code, based on the received application code.

19. The apparatus according to claim 18, wherein the runtime remodel function is performed in the client-as-a-service layer of the client terminal.

20. A non-transitory computer-readable storage medium storing computer-readable instructions thereon, which, when executed by processing circuitry, cause the processing circuitry to perform a method comprising:
receiving, by a user interface layer in a client terminal, application code input by a user;
processing the input application code by a client-as-a-service layer in the client terminal and forwarding the input application code to be stored in a cloud-based repository;
synchronizing application code stored in a cache with application code stored in the cloud-based repository; and
performing a runtime remodel on a runtime system based on the input application code.
